(19) United States
(12) Patent Application Publication
(10) Pub. No.: US 2016/0239920 A1
(43) Pub. Date: Aug. 18, 2016

(54) Crowd Funding Fraud Insurance

(71) Applicant: William Michael Cunningham, Temple Hills, MD (US)

(72) Inventor: William Michael Cunningham, Temple Hills, MD (US)

(21) Appl. No.: 14/580,188

(22) Filed: Dec. 22, 2014

(51) Int. Cl. G06Q 40/08; G06Q 20/40; G06Q 30/02

(52) U.S. Cl. CPC G06Q 40/08; G06Q 30/0279; G06Q 20/4016

(57) ABSTRACT

A safety product, system, processes and methods for crowdfunding campaigns. The disclosed embodiments allow one to transform information concerning the identity and vocational capabilities of those creating a crowdfunding solicitation from social media and search engines to determine the probability that the person or persons sponsoring the campaign are who they say they are and will be successful in completing the task(s) for which they are raising money. An electronic transaction is performed between a transaction device and a business connection server through a network. A crowdfunding fraud insurance policy is created, priced, offered and, if purchased, delivered to potential investor/supporter(s) of the specified crowdfunding campaign.

### U.S. PATENT DOCUMENTS

U.S. Pat. No. 8,352,295 B1 1/2013 Kobori, et al. 705/4-44
U.S. Pat. No. 7,974,861 B1 7/2011 Bohanek, Robert Michael. 705/4
2002/0147618 A1 1/2002 Mezrah et al. 705/4
US 2014/0257865 A1 9/2011 Gay, Christopher, et al. 705/4
US 2014/0185228 A1 7/2013 Dresner, Steven. 705/36
US 2014/0040157 A1 2/2014 Cohen, Meece, et al. 705/3 29
US 2014/0164289 A1 6/2014 Hanks, Knight, et al. 705/36
US 2014/0279682 A1* 9/2014 Feldman, Alexsandr. 705/36
US 2014/012780 A1 1/2014 Sanders, Aaron. 705/36

### OTHER PUBLICATIONS

Cunningham, William Michael, “Commentary: The quest for crowdfunding enters a complicated, but critical phase”, The Washington Post, Dec. 23, 2012.
Cunningham, William Michael, The JOBS Act: Crowdfunding for Small Businesses and Startups, New York: Apress. 2012. Print and electronic.

### CROSS-REFERENCE TO RELATED APPLICATIONS

This application claims priority to U.S. Provisional Patent application Ser. No. 61/963,980 entitled “Crowd Funding Fraud Insurance”, filed Dec. 20, 2013, which is hereby incorporated herein by reference in its entirety.

### BACKGROUND

Insurance is the practice of transferring risk from one party to another, typically in exchange for a payment. The payment, or insurance premium, is shifted from buyer to seller for a specified dollar amount of coverage or protection. In other words, an insurer (policy seller) sells a contract or policy that guarantees repayment to the insured (policy holder or buyer) in case of a loss generated by the occurrence of a specific event or set of events. In traditional terms, the insurance seller is most often a company. Companies typically use human representatives, agents, to act as an intermediary between the actual insurance customer and the actual life insurance company.

Crowdfunding, “open source” financing, is a technique that allow people to raise money using social media websites and tools. It is “the practice of funding a project or venture by raising many small amounts of money from a large number of people, typically via the Internet.”

Several have stated that a key issue in crowdfunding is the risk of fraud. (Barbara Roper, director of investor protection at the Consumer Federation of America, has been especially vocal in her concerns.) Those posting and soliciting crowdfunding donations and investments over the internet (referred to below as “crowdfunding assistance solicitors” or “person or persons applying for crowdfunding support,” or “crowdfunding applicant(s)”) may or may not be known to the persons who are considering making a donation or investment (referred to below as “crowdfunding fraud insurance buyers” or “person or persons seeking to buy insurance,” or “insurance buyers”).

Likewise, even if the person(s) seeking funds are who they say they are, there may be considerable uncertainty about this person's (or persons') ability to actually do what they are raising money to do. For example, assume you are, via crowdfunding, seeking to raise $100,000 for a restaurant. You post information on yourself and your effort on one or several registered crowdfunding websites. If I am considering making a donation or investment in your crowdfunding effort, a key question is: how do I know that you have the ability to create meals, to cook them, and to manage and run a restaurant? Unless I have personal experience with your capabilities, I cannot be certain. But this personal experience knowledge restriction is exactly the limitation that crowdfunding can overcome. Crowdfunding allows people to go outside of their networks, defined as those with personal experience of your identity and capabilities, to raise capital. This is the crowd part of crowdfunding.

On Apr. 5, 2012, President Barack Obama signed the Jumpstart Our Business Startups Act, better known as the JOBS Act. Small businesses and startups will be able to raise up to $1 million in equity (or debt) funding online via Crowdfunding Platforms—online communities and websites. A key issue in Crowdfunding is the risk of monetary loss due to fraud. The current embodiments allow people to protect themselves using a new and novel product: insurance on their crowdfunding expenditure. This particular solution solves a vexing problem in a clear and tangible manner. The steps involved in doing so observably and verifiably protect against the risk of monetary loss due to fraud. The product may provide monetary reimbursement of the funds or other assets invested if one or more fraud triggers are breached, fraud defined as “deceptive devices or statements intentionally used or made in order to secure unfair or unlawful gain.”

A crowdfunding campaign is a form solicitation posted on a crowdfunding platform or website. A crowdfunding platform user may spend hundreds or thousands of dollars supporting a given crowdfunding campaign. At the time of the creation of this invention, no insurance product was available that directly provided coverage for a crowdfunding platform user who is supporting a specific crowdfunding campaign with donations or investments. For example, if a crowdfunding campaign were found to be fraudulent, that is, if the persons creating the campaign were later determined not to have the identity claimed or were found to be soliciting funds for purposes that were not the stated purpose of the crowdfunding campaign, contributors will suffer a monetary and reputational loss. This may negatively impact the entire crowdfunding industry, since people considering making donations or investments to other, unrelated crowdfunding campaigns might be inclined or persuaded by the fraud not to do so.

Some have taken the approach that by conducting machine-assisted due diligence on firms and individuals seeking to crowdfund, the risk of fraud can be lowered, but due diligence is an inefficient, time consuming process that has the added disadvantage of not being effective or certain to reduce fraud (see: Bernard Lawrence “Bernie” Madoff). It is thus both ineffective and inefficient. In addition, due diligence processes are not immune from certain geographic, industry-related, racial, gender, age-related biases. Thus, it is entirely likely that due diligence services may simply propagate and heighten risk, not lower it. The embodiments presented here do not suffer from these issues, since they are machine based, efficient and neutral with respect to geographic, industry-related, racial, gender, age-related biases. They represent a better way to lower the risk of fraud. After all, simply being more efficient in conducting due diligence is not the same as actually reducing fraud, as proven by the recent financial crisis. There is a need for a new product that actually reduces the risk of fraud in crowdfunding, and does so in an efficient, bias-free, neutral manner.

In one implementation of the current embodiments, the insurance seller, or agent, may be a group of people. Via the current embodiments, we create a risk metric that allows people to sell insurance by accepting a certain level of risk, in conjunction with other insurance sellers. In other words, a group of people may be efficiently and effectively transformed into an insurance company, a transformation that is difficult to achieve without use of the system disclosed herein. Further, in one implementation, a product perceived as risky can be transformed into a safe (from the standpoint of risk of financial loss) product, a transformation that is, likewise, difficult or impossible without the use of the system described herein.

Thus, the disclosed embodiments represent an improvement in two technical fields:

crowdfunding and insurance. No current products are available that both protects contributors and investors while, simultaneously, offering a chance for crowdfunding industry participants to achieve a monetary gain external to the crowdfunding campaign as sellers of insurance. By turning the crowd into an insurance company, one additional benefit is to increase the accuracy of the fraud probability calculation and to engage far more people in the search for fraudulent activity.

Note that the current embodiments allow for the creation of micro insurance policies. The present invention not only efficiently turns the crowd into an insurance company while adding new features to the crowdfunding industry, but it advances an entirely new insurance product: crowdfunding microinsurance. Currently, microinsurance is defined as “a mechanism to protect poor people against risk . . . aimed primarily at the developing world's low-income workers, especially those in the informal economy who tend to be underserved by mainstream commercial and social insurance schemes.” Our implementation is different and better. In addition to supporting crowdfunding as a means by which poor people can create products, projects and companies that may get them out of poverty, by offering certain persons the ability to provide insurance and receive premium payments, we have added a significant cash flow generating financial tool to the marketplace.

In view of these limitations, there is a need for a tool that distributes crowdfunding risk efficiently, effectively, in a geographic, industry-related, racial, gender, age-neutral manner.

### SUMMARY

Donations or investments made to selected, specified crowdfunding campaigns may be insured against loss due to fraud. The crowdfunding campaign may be for commercial products and/or non-commercial endeavors (a crowdfunding campaign to raise money for a nonprofit social entity.) As part of this system, persons may be allowed to sell insurance by offering to compensate insured parties, in whole or in part, in case of a loss of donations or investments made to a crowdfunding campaign.

In one implementation, the Crowdfunding Insurance Product may be summarized as follows. A person seeking to raise capital for a company, product or project files a crowdfunding application online, over a network, on a crowdfunding portal. By law, certain crowdfunding applications must meet the information requirements laid out in the JOBS Act.

Once they have done so, the crowdfunding application is reviewed by the home or base crowdfunding portal or website. (Note that this website is completely different from the crowdfunding fraud insurance website.) If the crowdfunding application is approved by the home or base crowdfunding portal or website, the person or persons are allowed to post, on the home or base portal or website, a request that members of the public donate or invest in the company, product or project described in the crowdfunding solicitation.

In one implementation, our invention consists of a machine based, algorithmic evaluation process that transforms social media (Facebook®, Linked In®, Twitter®, or other social media networks not yet created) and other data, including search engine data, into an estimate of the validity of the identity of the person or persons applying for crowdfunding support. Our algorithm and process also links to meta (search engine generated) data sources, like Google® and Yahoo® (or other search engines not yet created) to determine both the identity and the capabilities of the person or persons applying for crowdfunding support.

In one implementation, we use this data to compute an estimate of the probability that the person or persons who have created the crowdfunding solicitation are who they say they are and to compute the probability that the persons raising money via crowdfunding will successfully carry out the tasks the company, product or project is seeking money for, as described in the crowdfunding solicitation. In other words, we calculate the chance that the company, project or product that is the subject of the crowdfunding campaign will be successful.

We calculate these probabilities through statistical techniques that compare data from the prospective crowdfunding person or persons to that from a comprehensive database containing information from all social media and crowdfunding platforms. These initial probabilities are used to refine the cost of crowdfunding fraud insurance, or the insurance premium. Once the insurance premium is calculated, a crowdfunding fraud insurance seller is offered a chance to sell protection. If accepted by the buyer, an insurance policy may be created and distributed to the crowdfunding fraud insurance buyer.

Note that this insurance can take other forms, such as a put option, giving a crowdfunding fraud insurance buyer the right, but not the obligation, to sell their crowdfunding donation or investment back to an insurance company or to the insurance providing crowd, or may take the form of a derivative contract.

The insurance product might provide monetary reimbursement of amounts donated or invested. The insurance system may generate a premium quote to insure the donation or investment made to the buyer or crowdfunding fraud insurance system user. The person making the donation or investment may then choose to pay the premium quote. In one application, a crowdfunding fraud insurance buyer may receive a receipt, proof of purchase, and/or other documentation pertaining to the crowdfunding insurance contract from the insurance seller.

In addition, the crowdfunding fraud insurance system described herein may generate an offer to monitor the specified crowdfunding campaign and send that offer to the user, who may or may not be the same as the insurance buyer. The user may accept the offer to monitor the crowdfunding campaign and the present embodiments may begin to watch the campaign. In one implementation, a crowdfunding fraud insurance buyer/user's computing device may have an application resident thereon that monitors the user's crowdfunding campaign activity, donations, investments, purchases and/or other crowdfunding related acquisitions. When the application detects that a crowdfunding campaign donation or investment has been made or acquired, the application may advise the present embodiments. The present embodiments may offer to insure or backup the donation or investment.

This summary is intended to introduce beneficial, formerly hidden, novel concepts, described below, in simple form. It is not intended to fully identify each and every key feature or essential feature of the claimed subject matter. Further, the scope of the claimed subject matter is not intended to be limited by this summary. Upon review of the disclosed embodiments, certain advantages will become obvious to persons with skill in the art.

### BRIEF DESCRIPTION OF THE DRAWINGS

FIG. 1 shows the general crowdfunding process.

FIG. 2 illustrates one version of a home or base crowdfunding campaign registration process.

FIG. 3 presents one version of a crowdfunding insurance process.

FIG. 3A shows one version of a general technical environment.

FIG. 3B clearly demonstrates the cost calculation for crowdfunding fraud insurance.

FIG. 3C provides more detail on one version of a process used in the creation of the crowdfunding fraud insurance.

FIG. 4 describes JOBS Act data to be inspected for completeness.

FIG. 5 shows one possible example of the calculation of a Crowdfunding Insurance Premium

FIG. 6 shows an example computing environment in which example embodiments and aspects of the current subject matter may be implemented.

FIG. 7 shows one version of a website that facilitates the current embodiments.

The summary above, and the following detailed description of illustrative embodiments, is better understood when read alongside the appended drawings. For the purpose of illustrating the embodiments, shown in the drawings are example constructions of the embodiments. Please keep in mind that the embodiments are not limited to the specific methods and instruments disclosed.

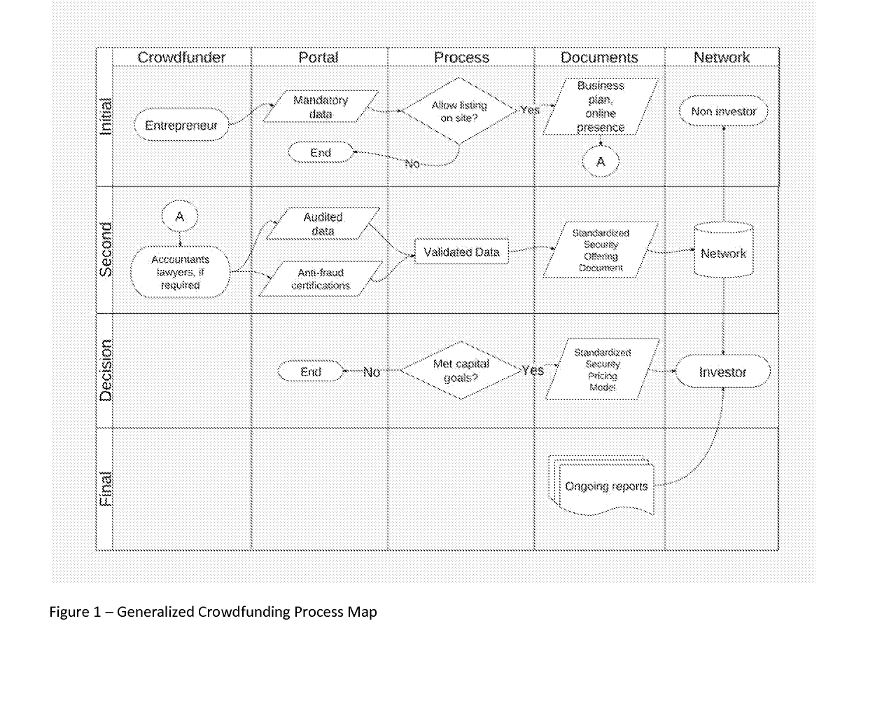

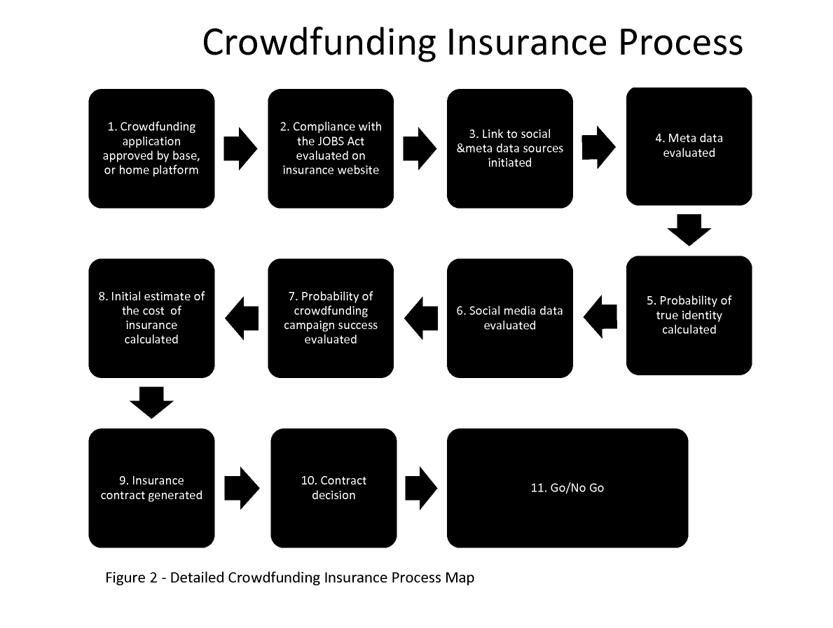

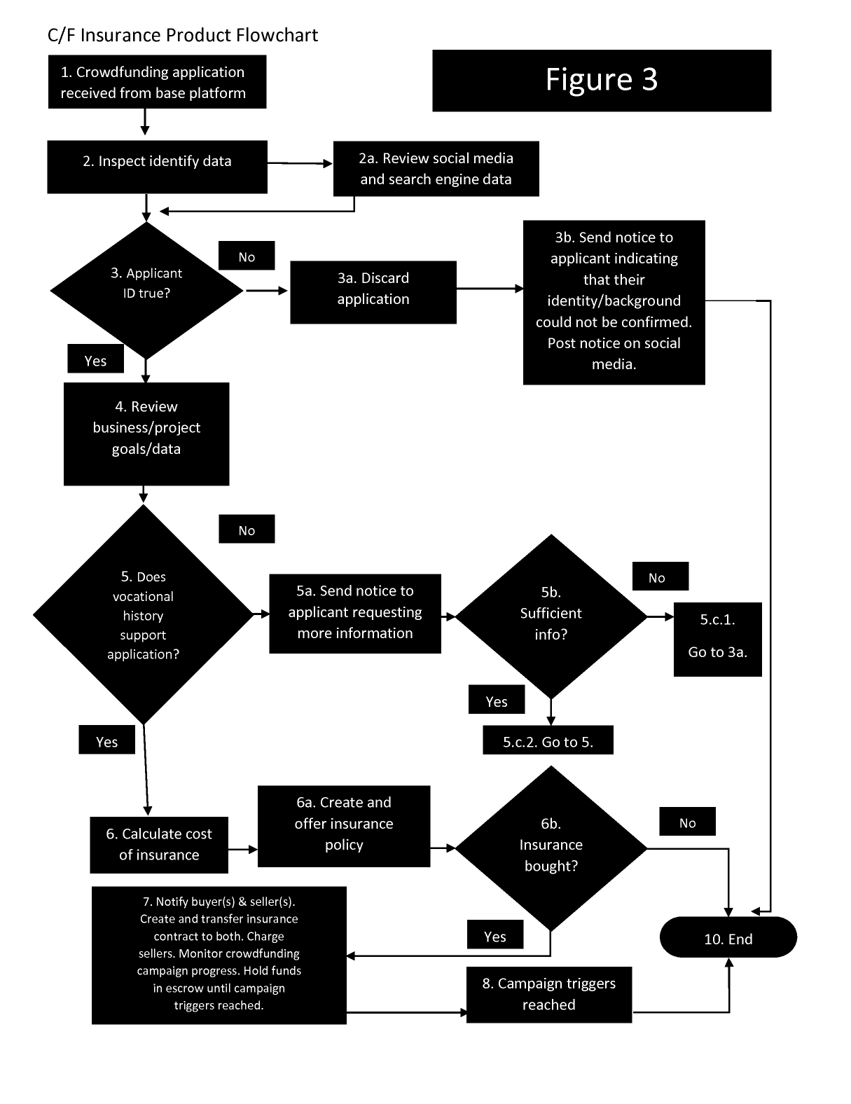

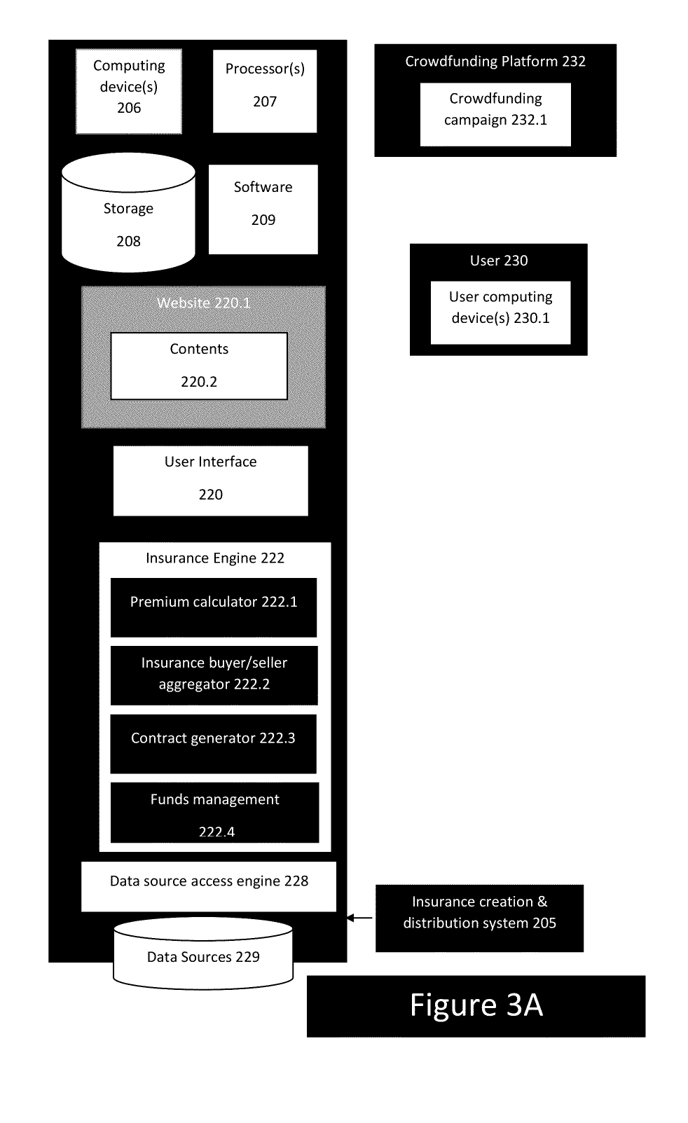

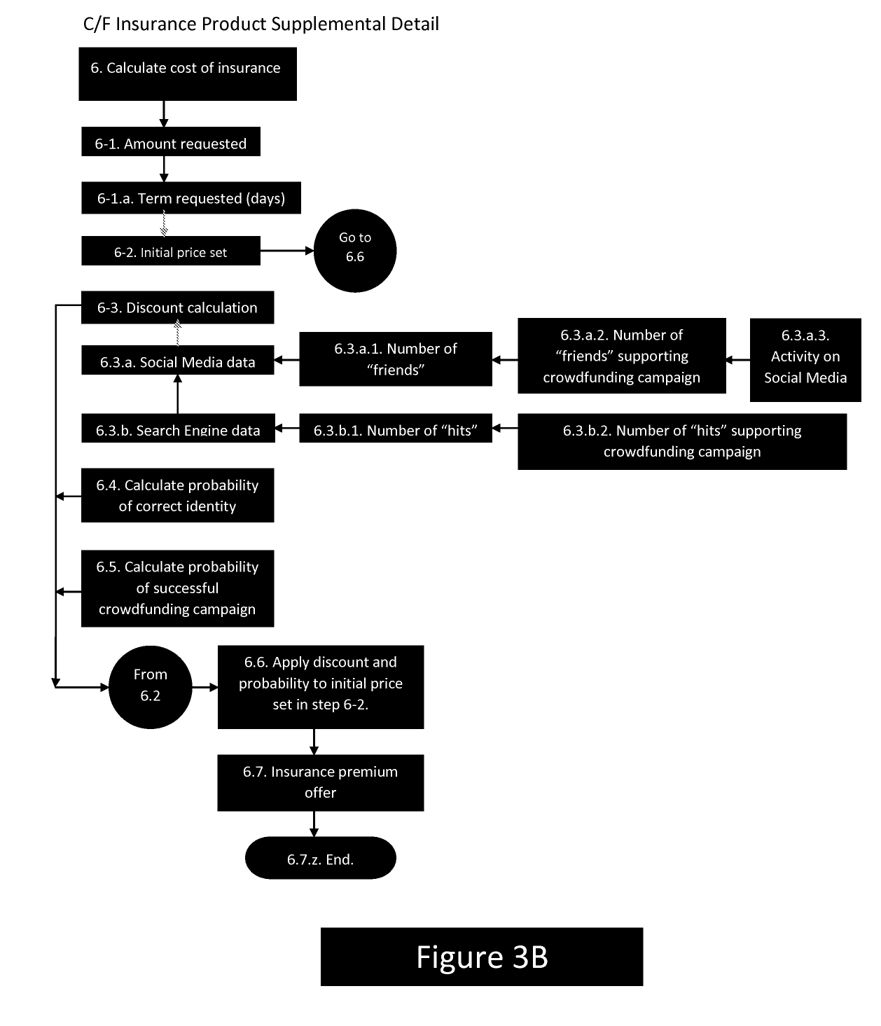

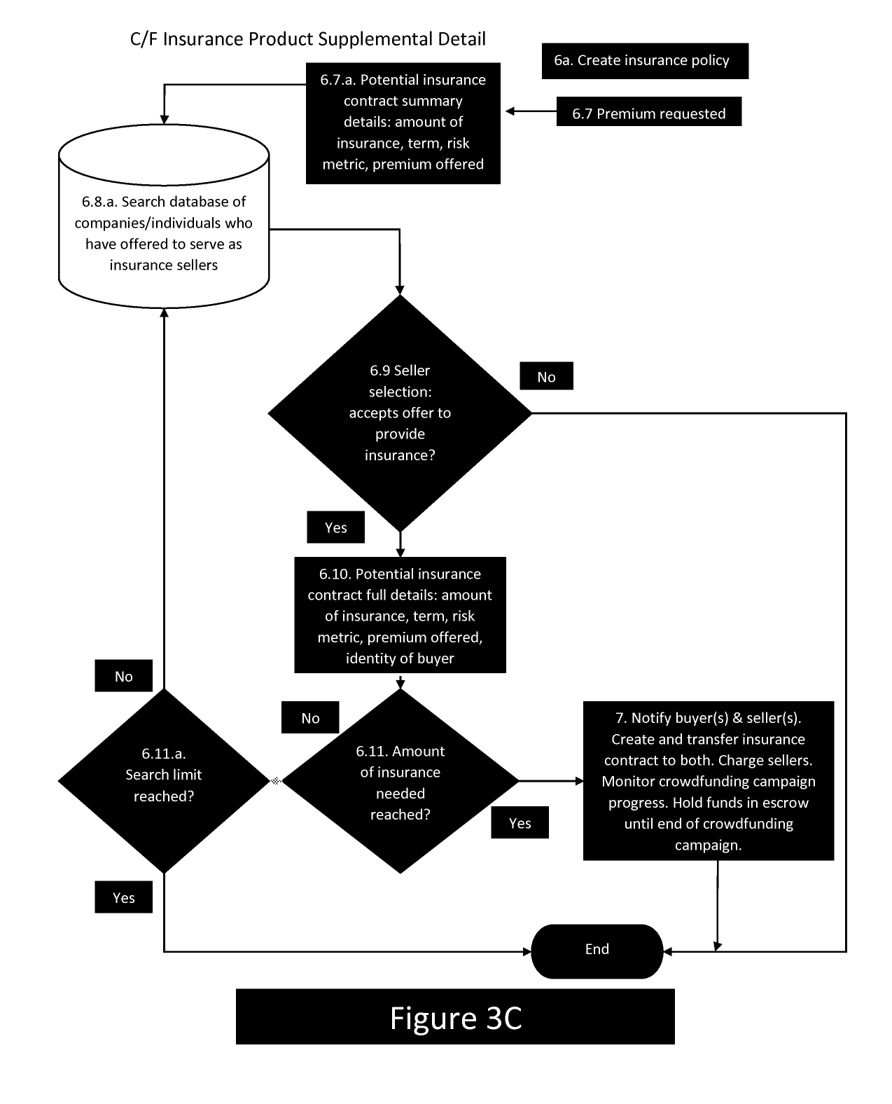

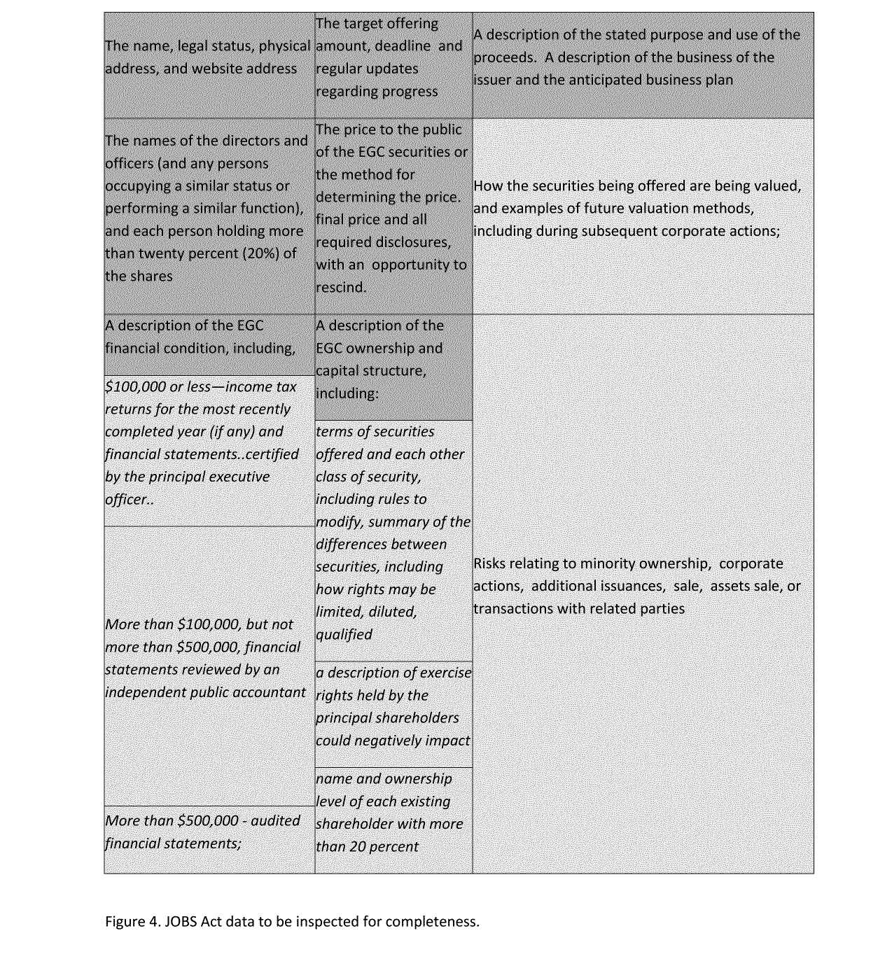

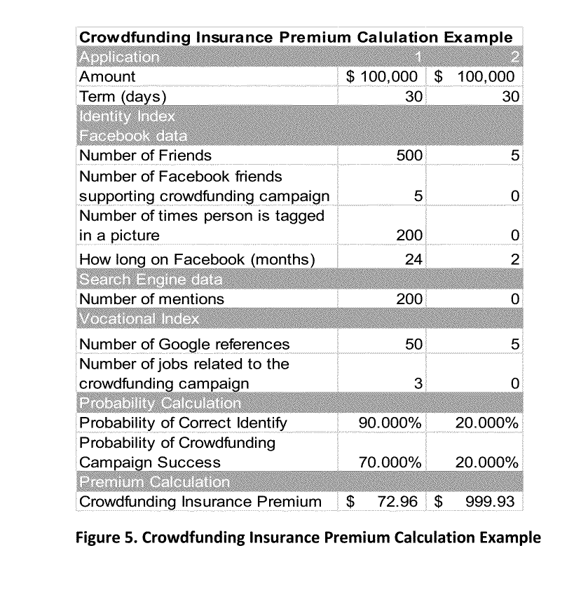

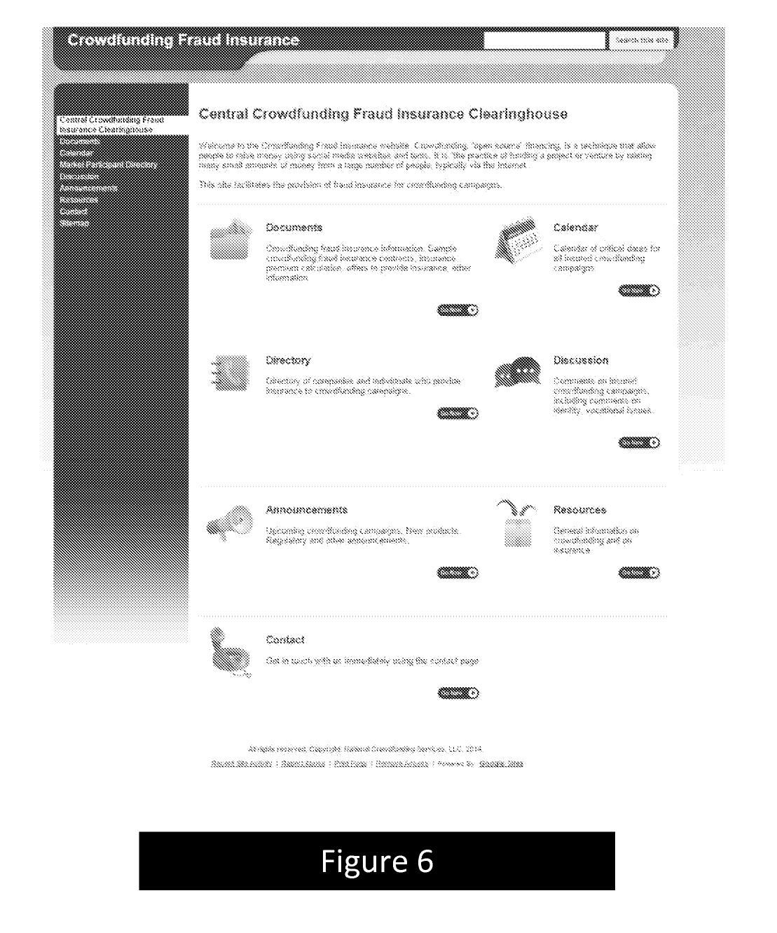

In the drawings: FIG. 1 is a block diagram of an implementation of a crowdfunding system, as outlined under current Federal law, that may be used to provide capital to small businesses; FIG. 2 is an operational diagram of the registration and usage of a generalized crowdfunding portal. FIGS. 3, 3A, 3B and 3C are a representation of one operational implementation of a method that may be used to provide crowdfunding fraud insurance; FIG. 4 is an operational listing of data required to be submitted by small businesses and individuals seeking to crowdfund under Federal law; FIG. 5 is an operational description of one possible version of the present device and shows another implementation of a method that may be used to provide crowd funding fraud insurance; and FIG. 6 is a set of pages showing an example computing environment in which example embodiments and aspects of the current subject matter may be implemented. FIG. 7 is a picture of a website that might facilitate the implementation of the present embodiments.

### DETAILED DESCRIPTION AND BEST MODE OF IMPLEMENTATION

While the descriptions below have been written with reference to certain equipment and industries, those skilled in the arts will see that the disclosed embodiments are appropriate and relevant to a wide range of applications in addition to those described below.

The current implementation enables network or WWW users to interact with a system to create and to purchase insurance that protects an insurance buyer against crowdfunding fraud.

The current implementation uses machine generated algorithms to evaluate information and data and to provide insurance services in support of crowdfunding, a new business financing technique.

The information and data may be used to authenticate the identity of a single individual or group of persons and to estimate the ability of that person or persons to successfully complete the business or project objectives and goals that are detailed in the crowdfunding campaign. Once these are evaluated, the cost of insurance is calculated. If the user so desires, they can purchase crowdfunding insurance to protect the investment or donation made to a crowdfunding campaign.

Embodiments of an electronic commerce system according to the present invention will be described below with reference to the drawings.

FIG. 1 is a flowchart diagram showing an example of configuration of an embodiment of a base electronic crowdfunding commerce system. In FIG. 1, the far left (first) column shows entrepreneurs as they approach the base crowdfunding platform or market. The next column represents home portals, online crowdfunding facilitators. Critical portions of the home, or base, crowdfunding process are shown in the middle column. Significant crowdfunding documents are in the next column. Finally, the column at right represents the crowdfunding network of investors and others. Notice that the first and last columns show people involved in the process. The rows represent phases of the process, defined as initial phase, the second phase, the decision phase, and the final phase.

In FIG. 1, entrepreneurs start by providing mandatory data to home portals, in the next column. The first decision point of the process is reached. Home portals must decide if they will allow the entrepreneur to list his or her solicitation on the site. If so, the process continues, and business plans are posted. The process moves to connector A, which is also where the present invention is engaged. Notice that at this point, there are no investors, hence the non-investor box in the last column.

In FIG. 1, connector A in the first column of the second row of the graphic, shows that unaudited and audited data are collected by home portals. Professional service providers, represented by insurers, accountants and lawyers, now join the process. These service providers may or may not be required, depending upon the amount of money being raised. (The figure assumes these service providers are engaged.) They create audited financial reports and the anti-fraud certifications required by the Act. These validated data are used in the next phase of the process shown. A standardized security document is created and distributed to the network of potential investors.

At this point in FIG. 1, note that the base network is divided into two categories: noninvestors and investors. Investors receive information from a standardized security pricing model, as required by the Act. Non-investors do not.

Base portals are required by the act to track fundraising goals for each company seeking funding. If the firm meets its fundraising goals, it moves to the final phase of the fundraising effort. Base crowdfunding companies are required to provide regular updates to investors, represented in the graphic by the box labeled ongoing reports.

Returning to the first row in FIG. 1, titled Initial and moving to the column titled Documents, we engage the current invention. Once the base or home crowdfunding portal application is approved, the insurance product evaluation begins, as noted in FIG. 2.

Although the application has been approved by the home crowdfunding site, in the present system, compliance with the JOBS Act is evaluated by the present embodiments. Crowdfunding campaign data is evaluated relative to its completeness and usefulness in the next stage of the process, which is represented in FIG. 2, Box 2.

Data concerning the identity of the individuals sponsoring the base crowdfunding campaign is linked to social & meta data sources (FIG. 2, Box 3) by the present embodiments. This includes data and information from social media websites like Facebook®, Twitter® and LinkedIn® and other yet to be created social media platforms. Information concerning the identity of the individuals sponsoring the crowdfunding campaign generated by the Google® or Yahoo® search engines, or other yet to be created search engines, is collected and stored in a temporary crowdfunding insurance transaction and information evaluation database by the present embodiments or insurance platform.

For example, to retrieve Facebook® data, an API that collects Facebook® data for a given user is constructed as follows for Facebook user John Doe:

GET graph.facebook.com

/search?
q={John Doe}&
[type={user}](#searchtypes)

This query is repeated for all persons associated with a given crowdfunding campaign. The query repeats, or loops, until information is collected on all relevant individuals.

Data collected is stored in a temporary query database. The information collected is used to evaluate the probability that the crowdfunders actually exist, to determine the strength of their social network, and as initial information used to calculate the likelihood that their crowdfunding campaign will succeed.

One example of how this portion of the system might be coded into a machine is as follows:

<?php
session_start( );
//$_SESSION[‘crowdfundingcampaign_rating’] = 1000; //reset campaign
to default
//get saved campaign rating
if(isset($_SESSION[‘campaign_rating’])){

| | |
|---|---|
| $campaign_rating | = $_SESSION[‘campaign_rating’]; |

| | |
|---|---|
| } else { $campaign_rating | = 1000; |

}
$opponent_rating = rand(0, 2000);
echo “Campaign Ranking: ”.$campaign_rating.“<br>”;
echo “Opponent Ranking: ”.$opponent_rating.“<br>”;
//formula explained -
$chance_of_success = abs((1 / ( 1 + pow(10, ( ($opponent_rating −
$campaign_rating) / 400) ) )) * 100);
//percentage
$chance_of_losingmoney = abs(100 − $chance_of_success);
//percentage
//output chances
echo $chance_of_success.“% chance of winning.<br>”;
echo $chance_of_losingmoney.“% chance of losing.<br>”;
//evaluate and output win and lose points
$k_factor = 32; //a common k factor
$win_points = round($k_factor * ($chance_of_losingmoney/100));
//k_factor * decimal number
$lose_points = round($k_factor * ($chance_of_success/100));
//k_factor * decimal number
echo ‘$win_points: ’.$win_points.‘<br>’;
echo ‘$lose_points: ’.$lose_points.‘<br>’;
//crowdfunding campaign launch - even odds
if($chance_of_success > 50){

$campaign_rating = $campaign_rating + $win_points;
echo “<br><strong>Campaign Wins</strong><br>”;
echo “Campaign Earns $win_points points<br>”;

} else {

$campaign_rating = $campaign_rating − $lose_points;
$campaign_rating = ($campaign_rating < 0 ) ? 0 :
$campaign_rating;
echo “<br><strong>Campaign Loses</strong><br>”;
echo “Campaign Loses $lose_points points<br>”;

}
//record campaign rating
$_SESSION[‘campaign_rating’] = $campaign_rating;
echo “Campaign Ranking: ”.$campaign_rating.“<br>”;
?>

Search engine meta data is then evaluated (FIG. 2 Box 4). The meta data contains information from all sources on the internet.

Information on the individual or individuals associated with or submitting a crowdfunding application is collected from all internet sources.

The algorithm used to do so from one source, Google®, for one individual, John Doe is coded into a computing machine as follows:

http://www.google.com/search?

start=0
&num=1000
&q=john+doe
&cr=countryUS
&lr=lang_en
&client=google-csbe
&output=xml_no_dtd
&cx=00255077836266642015:u-scht7a-8i

The search results are stored in a temporary electronic database and used to calculate the probability that the person or persons who have applied for crowdfunding are who they say they are. Social media data are also used in this process (FIG. 2 Box 5). Probability of true identity is calculated based on a point system that includes a review of the number of Facebook friends and LinkedIn connections one has (FIG. 2 Box 6). The quality of these connections is evaluated. The higher the number of confirmed, validated links one has, the higher the probability is that one is who they say they are, hence the higher the score.

Geographical address and government generated identity data, like social security information, may also be collected and used to confirm identity.

The probability of crowdfunding campaign success evaluated. The algorithm links identity and vocational information to the crowdfunding goals outlined and calculates the degree of distance between the two. The higher the probability that a crowdfunding applicant is who they say they are and the closer the activity crowdfunded is to the applicants' past vocational activity, the higher the probability that the applicant will be successful in meeting their crowdfunding goal (FIG. 2 Box 7).

The initial estimate of the cost of insurance calculated via an algorithm that uses the probability that identity is true, and the closer the activity crowdfunded is to the applicants past vocational activity the background and vocational information is, the lower the cost of the crowdfunding insurance (FIG. 2 Box 8). At this point, information on the amount of money being sought or raised and the term of the crowdfunding campaign (over what time period is the solicitation to be active, i.e. how long they are to be introduced into the system.)

Once this data is collected and evaluated, a decision whether or not to offer a crowdfunding fraud insurance contract decision is made (FIG. 2 Box 10). At this stage, a crowdfunding fraud insurance contract is generated electronically and offered to the crowdfunding website user.

At this point, the insurance contract buyer decides whether or not to purchase the crowdfunding fraud insurance contract (FIG. 2 Box 11).

If the user decides to purchase the insurance, a credit card or other payment transaction is initiated. If not, data concerning this potential transaction is deleted.

At this point, electronic commerce is commenced between a transaction device and a business connection server. An insurance contract is created.

The crowdfunding insurance buyers' account at a financial institution or their credit card is charged.

If funds are successfully transferred from insurance policy buyer to insurance policy seller, the insurance policy contract is activated.

An electronic message containing the insurance policy contract is sent to the crowdfunding fraud insurance contract buyer.

Although this description shows the case where classes such as a PC (personal computer) or cellular telephone, etc. are used as classes of the transaction devices, the invention may be applied to the case where PC is further classified into APPLE®, UNIX®, LINUX®, WINDOWS®, MS-DOS®, etc. as OS (operating system) classes.

Although the above description has been made about the case where the commodity to be suggested is an insurance commodity, the present invention may be applied to the case where the commodity to be suggested is another commodity, like a put option or other derivative contract. A put option is a contract giving the owner the right, but not the obligation, to sell a specified security at a specified price within a specified time. Those skilled in the art will understand that a put option is equivalent to an insurance contract, in that, structured correctly and for the appropriate dollar amount, a put option contract provides the put option contract buyer with the ability to recover the amount invested in a company or security, just like insurance.

According to the present embodiments, information concerning electronic commerce is collected into an electronic computing and memory storage device. Subsequently, the customer acquires the insurance commodity information in a timely manner.

Further, information concerning crowdfunding transactions is collected into a server such as a business connection server and into a specific machine. This process is outlined in FIG. 3.

Box 1 in FIG. 3 shows the process at the start, with the receipt from a base or home crowdfunding platform, by the current system of a crowdfunding application.

Box 2 in FIG. 3 represents the review and inspection of the data received in Box 1. This involves a completeness review, or a review to insure that all data required under the Jobs Act has been collected. This may include data listed in FIG. 4 titled “JOBS Act crowdfunding application data to be inspected for completeness.”

Box 3 in FIG. 3 outlines the first decision point in the insurance process. The embodiments quantify the probability that the identity of the crowdfunding applicant is true. The steps taken in calculating, based on social media data, this probability are described in more detail in FIG. 3B and utilized in FIG. 5.

Box 4 in FIG. 3 shows the process if the person applying for crowdfunding support is determined to have, with a probability of greater than 0.5, or 50%, accurately represented their identity. If this is the case, the system moves to the next stage of the process—determining the likelihood of business success.

If the identity of the person applying for crowdfunding support is determined to be false, the application for crowdfunding fraud insurance is discarded. This is shown in Box 3a. in FIG. 3.

The embodiment next uses information collected from social media and internet sources and described in detail in FIG. 3B to calculate the probability that the person or persons applying for crowdfunding support may be successful in reaching their business goals. The first step in this process is shown as Box 5 in FIG. 3, and is the next decision point. The steps taken in calculating, based on social media data, this probability are outlined in detail in FIG. 3B.

Based on Triangle 5 in FIG. 3, either it is determined that the applicant will have a solid chance (defined as a probability of success that is 0.5 (50%) or greater) of meeting their crowdfunding business objective, or the invention cycles to Step 5a, requesting more vocational information from the crowdfunding campaign solicitors. Box 5b shows the system either receiving sufficient information as required and requested, in which case the embodiments use the algorithm imbedded in step 5 to evaluate the vocational capabilities of the crowdfunding campaign solicitor(s), and moves to Bob 6, or it cycles to Step 3a in FIG. 3 and the crowdfunding fraud insurance application is discarded, with a notice sent to the crowdfunding applicants that their background could not be confirmed and the application is discarded.

FIG. 3, Step 6 shows the cost of crowdfunding fraud insurance being calculated. (FIG. 3B shows, in detail, the actual calculation of this cost.) Step 6a shows a policy being created and offered to a customer. (FIG. 3C shows this process in detail.) Triangle 6b shows the policy/product either being purchased or not purchased.

If the crowdfunding fraud insurance policy is not purchased, the process ends.

If the crowdfunding fraud insurance policy is purchased, FIG. 3 box 7 shows that the invention monitors the progress of the crowdfunding efforts to determine if any of the fraud triggers listed in the crowdfunding insurance fraud policy created and delivered in Step 6a are triggered.

FIG. 3A shows a block diagram of the generalized environment of a system that may be sued to provide crowdfunding fraud insurance. A system 200 may be constructed to allow for the construction of s tool that turns the crowd into an insurance company. A User 230 engages with a computing device 230.1 via a communications network like the Internet, a local area network (LAN), wide area network (WAN), cellular network, et al, and with a crowdfunding platform, like Fundrise.com, Indiegogo.com or Kickstarter.com, at 232. On the crowdfunding platform, the user engages with a specific crowdfunding campaign, 232.1, decides to donate money or invest at 232.1, and seeks insurance to protect the amount of money the user has provided to that specific campaign 232.1.

The user may then connect to a crowdfunding campaign insurance system, via interface 220. This system may have a website interface at 220.1, generated website content at 220.2, an insurance creation, generation and distribution engine 222 with a Premium Calculator 222.1 (also described in FIG. 3B) and an Insurance Aggregator used to transform the “crowd” into an insurance company 222.2 (also described in FIG. 3C).

The tool may have computing devices 206, processors 207, electronic memory or storage devices 208, and coded instructions that manage and control the aforementioned and other devices, retrieving instructions and executing certain software programs when required.

One implementation of the current subject matter may have a database of companies and people who have expressed an interest in participating in the provision of insurance in general or to specified crowdfunding campaigns 229. Access to this data may be controlled by a data source access engine 228.

FIG. 3B clearly explains how the cost of the insurance is calculated. In Block 6, the process initiates with a request for insurance. To determine this, the amount of insurance must be determined in Black 6.1. Note that this allows for the creation of micro insurance policies. If $100 dollars in insurance is requested, this might be obtained, with our system, via individual contracts/offers to provide $1 of insurance from 100 people.

In FIG. 3B, Box 6-1.a. shows the determination of the term of the insurance: 30, 60 or 365 days. Most crowdfunding campaigns currently last for 40 days. We anticipate that the standardized term of the insurance protection sold via this implementation will be 180 days, but note that there is no reason to limit the number of days the insurance runs. (Of course, the higher the term, the most costly the insurance, other things equal.)

In FIG. 3B, Box 6-2 shows the Initial Cost of Insurance being set. The initial cost will always be enough to cover the full dollar amount of protection requested. In other words, if you request insurance for a $100.00 donation or investment, the initial cost of the insurance may be $100.00. Discounts are then applied, as shown in Box 6.3.a. and 6.3.b. to lower this initial cost.

In FIG. 3B, Box 6-3 shows the calculation of the discount used to lower this initial price.

In FIG. 3B, Box 6.3.a.1 shows one step in the calculation, the importation of data concerning the number of “friends” the person or persons launching the crowdfunding campaign has. This may be collected from Facebook®, LinkedIn®, or other social media sites.

In FIG. 3B, Box 6.3.a.2. shows one implementation of the current subject matter using information on the number of social media “friends” to determine which of these “friends” are supporting the crowdfunding campaign at issue.

In FIG. 3B, Box 6.3.a.3. shows one implementation of the current subject matter using information on social media “activity” to help determine the probability of correct identity and the probability of crowdfunding campaign success.

In FIG. 3B, Box 6.3.b.1 shows one step in the calculation, the importation of data concerning the number of “hits” the person or persons launching the crowdfunding campaign have on search engine sites. This may be collected from Google®, Yahoo®, or other search engine sites.

In FIG. 3B, Box 6.3.b.2. shows one implementation of the current subject matter using information on the number of search engine “hits” to determine which of these “hits” cite or mention the crowdfunding campaign at issue.

In FIG. 3B, Box 6.4 shows the use of the information to calculate the probability of correct identity.

In FIG. 3B, Box 6.5 shows the use of the information to calculate the probability of crowdfunding campaign success.

In FIG. 3B, Box 6.6 shows the application of discounts being used to modify the initial insurance price determined in Box 6.2.

In FIG. 3B, Box 6.7 shows the initial cost of insurance being reflected to the insurance buyers and sellers. At this stage, the cost calculation process ends.

FIG. 3C clearly explains how the insurance itself is created. In Block 6.a., the process initiates with a request to create an insurance policy, contract or instrument.

In FIG. 3C Block 6.7, the amount of the insurance requested is input to an implementation that creates a summary request message (Block 6.7.a)

In FIG. 3C Block 6.8.a, this information is sent to a database of individuals and companies who have committed to providing insurance pledges.

In FIG. 3C Block 6.9, individuals and companies who have committed to providing insurance pledges determine if they will provide insurance for this specific request. If insurance sellers decline (No) to participate in this specific offering, they are dropped from this round of the search. If insurance sellers want (Yes) to participate in this specific offering, they are sent to Black 6.10.

In FIG. 3C Block 6.10, individuals and companies who have committed to providing insurance pledges for this specific request are sent enhanced summary information, including the identity of the person requesting insurance coverage, term and dollar amount information, information on the calculated (Block 6.7) premium, and other information to be determined.

In FIG. 3C Block 6.11, the implementation cycles through the database at 6.8.a. until enough insurance coverage is accumulated from persons and companies in the database.

In FIG. 3C Block 6.11.a., the cycle is shown being limited by a fixed number of searches. The limit cannot exceed n, where n equals the number of individuals and companies in the database at 6.8.a.

In FIG. 3C Block 7., one implementation of the current subject matter is shown accumulating sufficient insurance pledges, creating a contract, distributing the contract to both buyers and sellers, collecting funds from the buyer of the insurance, distributing a pro-rata share of the premium collected to the sellers, monitoring the crowdfunding campaign, holding funds and paying out if fraud triggers are breached.

FIG. 5 shows the insurance premium calculation steps as represented by Step 6 in FIG. 3.

The system starts with a review of the dollar amount sought via crowdfunding and the term of the crowdfunding effort, or how long the solicitation will last.

Using data from social media websites, the system selects data showing the number of Facebook® (or other social media) friends the crowdfunding campaign solicitor (or solicitors) have. It also selects information, using the algorithm described above, concerning the number of these “Friends” who have contributed to the crowdfunding campaign.

Next, the system reviews information on the number of times the crowdfunding campaign solicitor (or solicitors) have been tagged in Facebook® (or other social media) photos.

Next, the system reviews information on the age of the Facebook® (or other social media) websites account for the crowdfunding campaign solicitor (or solicitors).

Next, the system reviews information collected from Google®, Yahoo® (or other search engines) on the number of times the crowdfunding campaign solicitor (or solicitors) have been mentioned online.

Next, the system reviews information on the relevance of these search engine references to the business activity that is the subject of the crowdfunding campaign.

Next, the system reviews information on the number of jobs that the crowdfunding campaign solicitor (or solicitors) have had that are related to or relevant to the business activity that is the subject of the crowdfunding campaign.

Next, the system calculates the probability that the identity of the crowdfunding campaign solicitor (or solicitors) is true.

Next, the system calculates the probability that the crowdfunding campaign business activity will be realized.

A cost of insurance is calculated based on one version of the present embodiments as described. In the example shown in FIG. 5., the Crowdfunding Insurance Premium for Application 1 is $72.96. the Crowdfunding Insurance Premium for Application 2 is $999.93. This is the amount referenced as the cost of insurance in Box 6 in FIG. 3.

In addition, information concerning the privacy of the user, such as log information concerning electronic commerce on a network, or the like, is prevented from disclosure.

1. A method for collecting information relating to a crowdfunding application on a given crowdfunding website and assembling and evaluating identity and potential business performance data relating to the crowdfunding applicant, resulting in the offering of a fraud insurance policy to a consumer where the method comprises the acts of:
(a) capturing identify information about one or more applicants;
(b) capturing basic identification information about the applicant, wherein the basic identification information is taken from social media and other websites;
(c) electronically retrieving additional, non-transactional information about the applicant from a social media information database, wherein the social media information database is indexed by the basic identification information taken from the crowdfunding applicant's social media (Facebook®, Twitter®, LinkedIn®, etc.) website, and wherein the consumer is required by the crowdfunding website to maintain up-to-date information in the social media information database;
(d) electronically assembling a identify confirmation and vocational data record by combining the crowdfunding application information, the additional, non-transactional social media information and the basic identification information;
(e) storing the identify confirmation and vocational data record in a transaction database;
(f) periodically updating the identify confirmation and vocational data record with updated additional, non-transactional information by periodically electronically retrieving updated additional, non-transactional information about the crowdfunding applicant from social media, government and non-governmental information database; and
(g) analyzing the social media and vocational data record of the crowdfunding applicant to determine whether the crowdfunding insurance applicant meets predefined criterion for the issuance of a crowdfunding fraud insurance policy action.

2. A method for collecting and analyzing information relating to crowdfunding applicant identity and vocational information and assembling this data relating to the crowdfunding applicant, where the method comprises the acts of:
(a) capturing information about a crowdfunding applicant's identity, including information about the applicant's vocational skills;
(b) reading the crowdfunding applicant's government-issued identification card to acquire basic identification information about the crowdfunding applicant's identity at the time of application, wherein the basic identification information includes an identification number that is stored on the government-issued identification card;
(c) acquiring the crowdfunding applicant's address by electronically retrieving the crowdfunding applicant's address from an address database, wherein the address database is maintained by the government and is indexed by the identification number read from the crowdfunding applicant's government-issued identification card, and wherein the government requires the crowdfunding applicant to keep an up-to-date address in the address database;
(d) electronically assembling an identity data record by combining the social media generated information and the basic identification information with the address acquired in act (c);
(e) storing the identify and vocational data record in a crowdfunding applicant transaction database;
(f) periodically updating the identify and vocational data record in the crowdfunding applicant transaction database by again electronically retrieving the crowdfunding applicant's address from the address database and updating the crowdfunding applicant's address in the data record if it has changed; and
(g) analyzing the identify and vocational data record to determine whether the crowdfunding applicant meets predefined criterion for an insurance action based on the crowdfunding applicant's social media profile and address, wherein the predefined criterion relates to probability that the crowdfunding applicant's identify is true and the crowdfunding applicant's vocational history supports the business, project or person that is the subject of the crowdfunding campaign.
